(19) United States
(12) Patent Application Publication
(10) Pub. No.: US 2013/0146700 A1
(43) Pub. Date: Jun. 13, 2013

(54) AERIAL REEL

(71) Applicant: David WIGARD, Courtenay (CA)

(72) Inventor: David WIGARD, Courtenay (CA)

(21) Appl. No.: 13/708,242

(22) Filed: Dec. 7, 2012

Related U.S. Application Data
(60) Provisional application No. 61/568,395, filed on Dec. 8, 2011.

(51) Int. Cl. A62C 33/04

(52) U.S. Cl. CPC A62C 33/04
USPC 242/407; 700/213

(57) ABSTRACT

An aerial reel that can be suspended from a helicopter for laying out and picking up a flexible length of material, such as a fire hose, is described. The aerial reel includes a rotatable spool for winding and unwinding the hose around, a pick-up member attached to the spool for automatically or manually connecting to the fire hose, an actuatable drive system engaged with the spool for rotating the spool in either direction, and a frame with an attachment system for connecting the spool to the helicopter. The aerial reel is controlled by the helicopter pilot through the cockpit controls, and does not require the use of a person on the ground when laying out and picking up the fire hose.

### CROSS REFERENCE TO RELATED APPLICATIONS

This application claims the benefit of priority under 35 U.S.C. §119 and 35 U.S.C. §120 of the U.S. Provisional Application 61/568,395, filed on Dec. 8, 2011, the entire contents of which are incorporated herein by reference.

### FIELD OF THE INVENTION

An aerial reel that can be suspended and operated from an aircraft capable of hovering is described. The aerial reel is particularly useful for laying out and picking up a flexible length of material, such as a hose or cable as may be required in the field for fighting forest fires.

### BACKGROUND OF THE INVENTION

Wildfires are widespread throughout many parts of the world and they can cause extensive damage to property and human life, as well as having widespread ecological effects. Many organizations devote significant time, money and resources to wildfire management, including wildfire prevention, detection and suppression. Fire management can be very costly and is particularly costly with regards to fire suppression itself due to the large requirements for personnel, fire-fighting equipment and the operational costs of fire-suppressing aircraft. In the United States it is not uncommon for suppression operations for a single wildfire to exceed costs of $1 million (USD) in just a few days. In a typical year in Canada there can be over 9,000 forest fires, burning an average of 2.5 million hectares or 25,000 square kilometers, with average suppression costs being between $300-500 million (CAD) annually. Costs are attributable to both personnel and equipment costs including the costs of operating helicopters for the ferrying of equipment and personnel to and from the fire areas.

Wildfires are often in remote locations where they are difficult to access. One common fire suppression technique is to fly a ground crew of fire fighters into the area near the fire where the fire fighters lay out lines of hose from a nearby source of fire retardant, such as a lake, river, well, pond, or other body of water, to the burning area. The lines of hose are typically in 100 foot lengths which is a practical limit due to the weight of the hose that can be handled by a firefighter. In some locations where the most accessible fire retardant source is far away from the fire, the firefighters may spend long periods of time manually laying out and interconnecting thousands of feet of hose. The hoses often need to be laid across variable and difficult terrain that may contain features such as rock bluffs, swamps, marshes and ponds that can not be easily maneuvered through or around by firefighters. Accordingly, for many fire suppression operations, the manual laying out of long lengths of fire hose can be a difficult and timely process that is physically demanding on firefighters.

Moreover, forest firefighting is by nature a high risk occupation, and accidents such as slips and falls can easily happen during the manual laying out of hose. Safety is often the first priority for firefighters, and any improvement in fire suppression techniques that can reduce the risk of injury and reduce fatigue in firefighters would be beneficial.

Furthermore, when fire suppression operations are near completion in an area, the fire hoses must be manually drained and rolled up by the firefighters. As the hoses have been used for pumping water, they are typically very wet and heavy, making draining and rolling the hoses a sloppy and difficult job. Compounded with the fatigue from spending days or weeks fighting the fire, this can be an equally physically challenging job for firefighters.

Accordingly, there is a need for a quick and simple method and apparatus for laying out fire hose across remote and/or challenging terrain. There is also a need for devices that can effectively drain and pick up fire hoses that have been used for wildfire suppression. There is a further need for a method to lay out and pick up fire hose that reduces firefighter fatigue and increases safety.

As noted above, helicopters are a key piece of equipment in fighting fires that provide a multitude of functions including directly combatting fires by delivering fire retardant to the fire and also as a means of moving personnel and equipment. While helicopters have been used for delivering and collecting equipment including fire hose to and from locations, helicopters have not been used specifically for the deployment and collection of that fire hose.

In addition, the management of fire-fighting equipment within the field is a complex process that can often lead to the loss of equipment within the field. When equipment is not found in the field, substantial costs are often incurred looking for the equipment. In addition, not only is it expensive from a personnel and hardware-time perspective (eg. helicopter time) looking for lost equipment, when equipment is not found, there is the capital cost of replacing the lost equipment. As such, there has been a need for an inventory control system that effectively monitors the location of equipment both in and out of the field.

A review of the prior art reveals various systems that have been used with helicopters for deploying various pieces of equipment in the field. For example, U.S. Pat. No. 3,759,330 describes a method for setting up a hose between a source of fire retardant material and an airborne distributer; U.S. Pat. No. 3,586,256 and GB Patent No. 2,069,444 describe helicopter-carried devices for laying out wire or line under tension; and, U.S. Pat. No. 4,993,665 describes a load frame for attachment to a helicopter. Importantly, the prior art does not reveal a method and apparatus for laying out and picking up fire hose that solves the previously described problems.

### SUMMARY OF THE INVENTION

In accordance with the invention, there is provided an aerial reel for operative connection to an aircraft for picking up and deploying lengths of flexible material to and from the aerial reel, the aerial reel comprising: a rotatable spool having a frame for operative attachment to the aircraft; an actuatable drive system operatively connected to the rotatable spool and frame for selective rotation of the rotatable spool with respect to the frame; a pick-up system operatively attached to the rotatable spool, the pick-up system for attaching an end of a length of flexible material to the rotatable spool to facilitate winding of lengths of flexible material on the rotatable spool.

In one embodiment, the pick-up system includes a pick-up control system within the aircraft enabling operator actuation of the pick-up system from within the aircraft. The pick-up system may also include an extension and retraction system for extending the pick-up system outwardly from the rotatable spool. The extension and retraction system may be connected to the central rotatable core.

In one embodiment, the extension and retraction system is a passively or actively driven gas cylinder system. In the passive embodiment, the extension and retraction system extends away from the central rotatable core when the extension and retraction system is positioned on the underside of the central rotatable core.

In another embodiment, the extension and retraction system is an actuatable scissor mechanism.

In one embodiment, the pick-up system is an actuatable electromagnet that extends along the length of the spool.

In one embodiment, the rotatable spool comprises first and second flanges on either ends of the cylinder, and at least one of the flanges has a track on an inner surface engaged with at least one of the ends of the electromagnetic bar for guiding the extension and retraction of the electromagnetic bar.

In one embodiment, the pick-up system comprises a hook.

In yet another embodiment, the rotatable spool further comprises a visual indicator for indicating the position of the pick-up system. The visual indicator may be a colored line along the length of the rotatable spool on the opposite side of the rotatable spool relative to the pick-up system.

In a still further embodiment, the actuatable drive system includes a drive control system for connection within the aircraft enabling operator control of rotation of the rotatable spool from within aircraft. The actuatable drive system may be a hydraulic drive system having a hydraulic motor and/or an electric drive system having an electric motor.

In one embodiment, the actuatable drive system has a gear system having more than one gear ratio enabling the generation multiple spool rotation speeds.

In one embodiment, the gear ratio of the actuatable drive system has means for automatically adjusting the speed of rotation of the rotatable spool based on the speed of the aircraft.

In a further embodiment, the aerial reel includes at least one rigid or semi-rigid connection line for attaching the frame to the aircraft and wherein the connection line when attached to the aerial reel prevents the aerial reel from spinning about a vertical axis relative to the aircraft while aloft.

In another embodiment, the aerial reel includes a radio frequency identification (RFID) reader operatively connected to the rotatable spool for detecting an RFID tag operatively connected to a length of the flexible material.

In another aspect, the invention provides an aerial reel for suspension from an aircraft comprising: a frame; a rotatable spool in operative connection with the frame, the rotatable spool including a reversible drive system for rotating the spool in clockwise and counterclockwise directions, the drive system including a drive control system for connection to the aircraft enabling operator control of the rotatable spool from within the aircraft; and a pick-up system in operative connection with the rotatable spool, the pick-up system including: an actuatable electromagnetic bar extending along the length of the rotatable spool and rotatable with the rotatable spool for attaching to a flexible length of material to be carried on the rotatable spool; an extension and retraction system for extending the electromagnetic bar outwardly from the rotatable spool and retracting the electromagnetic bar inwardly towards the rotatable spool; and a pick-up control system connected to the aircraft enabling operator control of the aerial reel from within the aircraft.

In yet another aspect, the invention provides a system for managing the deployment and collection of fire-fighting hose comprising: a plurality of hose lengths each having an radio frequency identification (RFID) tag; at least one aerial reel for operative connection to an aircraft, each at least one aerial reel having an RFID reader operatively connected to the aerial reel, the RFID reader detecting the attachment or disconnection of a specific hose length to the aerial reel; and a hose database operatively connected to each RFID reader, the hose database having means for marking a specific hose length as attached to or disconnected from an aerial reel.

In another embodiment, the system also includes a GPS mapping system operatively connected to the hose database, wherein the GPS system maps the location of an individual hose length when a hose length is disconnected from an aerial reel.

In yet a further embodiment, the system includes separate GPS mapping systems in individual aircraft, each GPS mapping system receiving and storing RFID and GPS data of individual hose lengths carried and deployed by the individual aircraft.

In one embodiment, the separate GPS mapping systems include means for transferring RFID and GPS data stored within each GPS mapping system to a central computer via a wide area or local area network.

### BRIEF DESCRIPTION OF THE DRAWINGS

The invention is described with reference to the accompanying figures in which:

FIG. 1 is a perspective bottom view of an aerial reel in accordance with one embodiment of the invention;

FIG. 2 is a front perspective view of an aerial reel in accordance with one embodiment of the invention;

FIG. 3 is right perspective view of an aerial reel in accordance with one embodiment of the invention;

FIG. 4 is a left side view of an aerial reel showing a drive mechanism in accordance with one embodiment of the invention;

FIG. 5 is a top perspective view of an aerial reel attached to an aircraft from the point of view of an aircraft operator in accordance with one embodiment of the invention;

FIG. 6 is a bottom perspective view of an aerial reel attached to an aircraft in accordance with one embodiment of the invention;

FIG. 7A is a schematic front view of a scissor mechanism for extending and retracting an electromagnetic pick-up bar on an aerial reel, the bar shown in the retracted position in accordance with one embodiment of the invention;

FIG. 7B is a schematic front view of a scissor mechanism for extending and retracting an electromagnetic pick-up bar on an aerial reel, the bar shown in the extended position in accordance with one embodiment of the invention;

FIG. 8 is a front perspective view of an electromagnetic pick-up bar extendable and retractable via gas springs of an aerial reel in accordance with one embodiment of the invention;

FIG. 9A is a schematic front view of a gas spring extension system for an electromagnetic pick-up bar of an aerial reel shown in a retracted position in accordance with one embodiment of the invention;

FIG. 9B is a schematic front view of a gas spring extension system for an electromagnetic pick-up bar of an aerial reel shown in an extended position in accordance with one embodiment of the invention;

FIG. 10 is a schematic side view of a trailer system for deploying hose in accordance with one embodiment of the invention; and

FIG. 11 is a schematic overview of a typical deployment of an aerial reel utilizing a Radio Frequency Identification and Global Positioning System in accordance with the invention.

### DETAILED DESCRIPTION OF THE INVENTION

With reference to the figures, an aerial reel for deploying and retrieving fire fighting hose from an aircraft is described. In the context of this description, while the invention is described with reference to fire hose, it is understood that the systems described herein may be used for other equipment. It is also understood that aircraft capable of hovering are the type of aircraft with which the invention is described. Such aircraft will primarily include helicopters, however, it is understood that other aircraft including lighter-than-air aircraft may also be used.

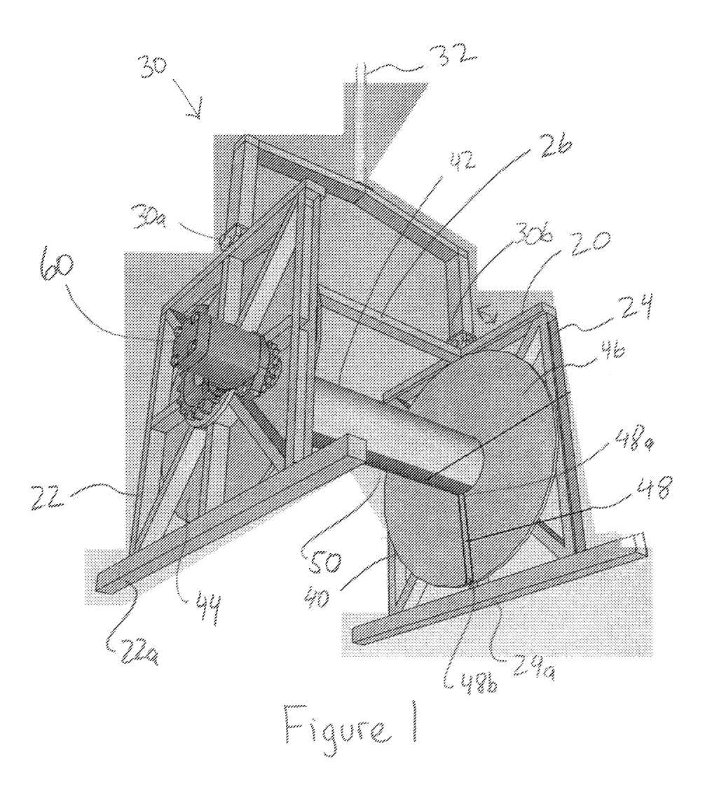

Referring to FIGS. 1-6, an aerial reel 10 having a frame 20, a spool 40 and a drive system 60 and its use with a helicopter are described.

### Frame and Attachment System

Referring to FIG. 1, the frame 20 of the aerial reel comprises a first and second frame end 22, 24 connected by a horizontal member 26, each frame end having a bottom skid 22a, 24a. An attachment system 30 is connected to the top of each frame end via hinges 30a, 30b. The hinges pivot forwards and backwards to allow the aircraft to land while the aerial reel is attached to the aircraft and/or to allow for easy attachment of the aerial reel to the aircraft.

The attachment system is used to suspend the aerial reel from an aircraft 80 and to prevent the aerial reel from spinning while aloft. The attachment system includes at least one connector line 32 for connecting the attachment system to the aircraft. The attachment system may include a single or multiple connector lines that prevent the aerial reel from spinning while aloft. The connector line will typically be a single or multiple rigid bars, semi-rigid lines or flexible lines that are configured to prevent the aerial reel from spinning. The connector line may also be telescopic to facilitate storage of the connection system.

The length of the connector line will generally be determined by the height of trees in the area the aerial reel is being used. In other words, the connector line should be sufficiently long such that the aircraft will clear the tops of the trees when the aerial reel is attached to the helicopter and the helicopter is hovering with the aerial reel just above the ground. The length of the connector line may be fixed or adjustable, with a typical line being approximately 50 feet (15 m).

The connector line will preferably be fabricated from materials such as aluminum, fiber glass or carbon fiber in order to minimize weight and may be assembled from sections in order to enable simpler ground transportation.

### Spool and Pick-Up System

The spool 40 comprises an axial cylinder 42 with a first and second flange 44, 46 on either end of the cylinder and defining the outer surfaces of the spool. The ends of the cylinder are attached to the frame ends 22, 24 via a bearing system. The spool is used to store the hose (not shown), and the drive system 60 generally enables the spool to be rotated in both clockwise and counter-clockwise directions to deploy the stored hose and to wind up hose that has been deployed. The drive system, as discussed in further detail below, is controllable from the aircraft. Preferably, the spool will also have a neutral position that enables the system to be manually wound or un-wound. The spool may be provided with a manual crank arm (not shown) to allow the manual winding or un-winding of the spool as may be desired in the field.

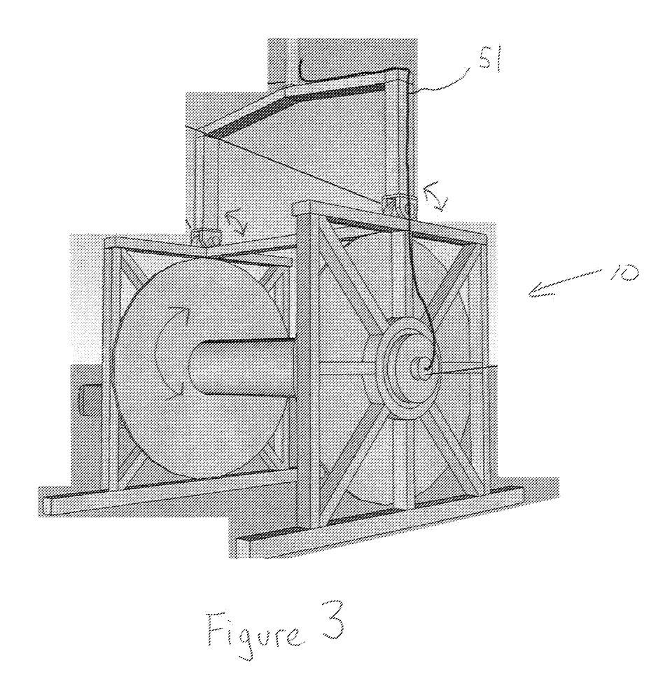

The spool also includes a pick-up system for initiating hose pick-up and connection to the axial cylinder such that hose can be wound onto the spool. As best shown in FIGS. 1, 7A and 7B, 8, 9A and 9B, in one embodiment, the pick-up system includes an actuatable magnetic or electromagnetic bar 50 on or in the cylinder 42 of the spool that rotates with the cylinder. When actuated, the magnetic or electromagnetic bar attracts and secures an end of the fire hose that may include a corresponding magnetic coupling, sleeve, or other magnetic attachment on the hose. In the case of an electromagnetic, the electromagnet is connected by wiring 51 (see FIG. 3) to the aircraft controls, allowing the pilot of the aircraft to magnetize and de-magnetize the electromagnetic bar through the aircraft controls.

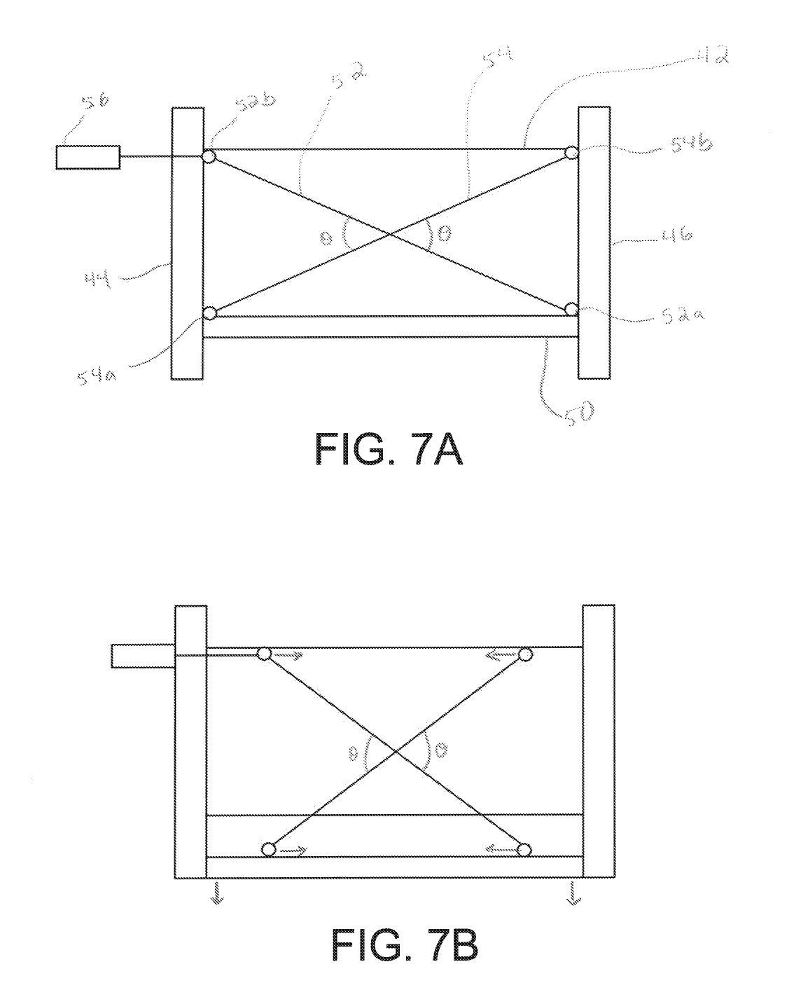

To facilitate easy pick-up of the fire hose, the electromagnetic bar 50 extends distally from the cylinder 42. In one embodiment, one or both of the flanges 44, 46 of the spool include a track 48 that is engaged with one or both the ends of the electromagnetic bar, enabling the electromagnetic bar to move along the track between a retracted location at a first end 48a of the track and an extended location at a second end 48b of the track that is at or near the outer edge of the flange. The movement of the electromagnetic bar within the track may be passive or active. For example, the electromagnetic bar may be moved to an outer position by gravity when the position of the electromagnetic bar is on the underside of axial cylinder. Alternatively, the movement may be active through the use of an appropriate actuation mechanism. For example, actuation may be achieved by a scissor mechanism located inside the spool cylinder 42 as shown in FIGS. 7A and 7B. In this example, the scissor mechanism includes a first support 52 and a second support 54 configured in an “X”. A first end of each support 52a, 54a is operatively engaged with the electromagnetic bar 50 and a second end of each support 52b, 54b is operatively engaged with an inside edge of the cylinder opposite the electromagnetic bar. A linear actuator 56 is operatively engaged with the first or second support. When the electromagnetic bar is retracted as in FIG. 7A, actuation of the linear actuator causes the angle a to increase, the second ends of the supports 52b, 54b to slide along the inside of the cylinder towards the center, the first ends of the supports 52a, 54a to slide along the electromagnetic bar 50 towards the center, and the electromagnetic bar to extend downwards as shown in FIG. 7B. The linear actuator can be used to reverse this process to retract the electromagnetic bar.

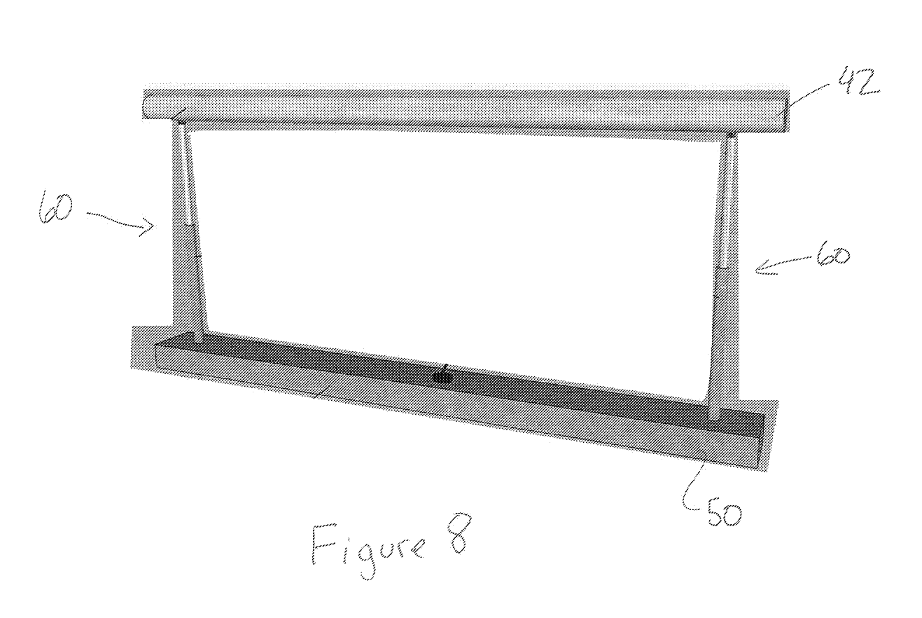

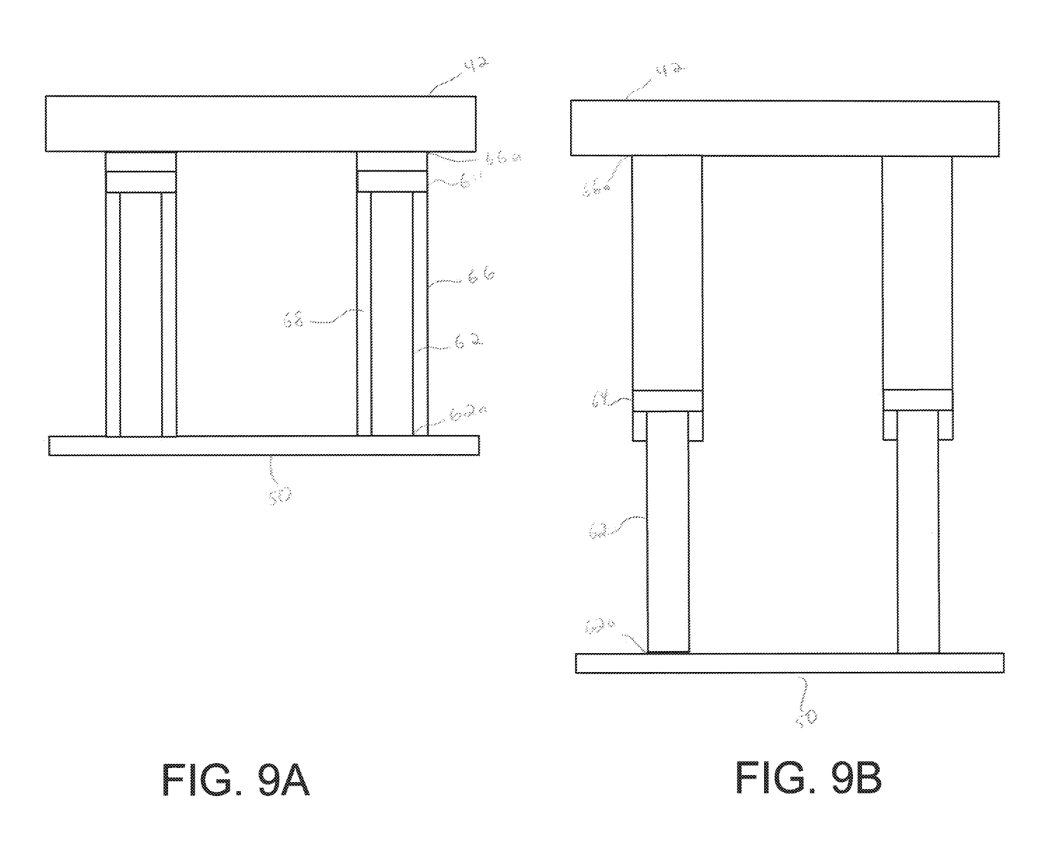

In another embodiment shown in FIGS. 8, 9A and 9B, the pick-up system includes gas springs 60 for extending and retracting the electromagnetic bar 50 from the spool cylinder 42. Each gas spring comprises a rod 62 and piston 64 telescopically displaceable within a tube 66. A first end 62a of the rod is attached to the spool cylinder 42 and a first end 66a of the tube is attached to the electromagnetic bar 50. Within the tube are sealed cavities 68, 68a containing gas on opposite sides of the piston. When the cylinder 42 is positioned such that the electromagnetic bar is on the bottom side of the cylinder, as shown in FIG. 9A, the force of gravity is large enough that it causes the tube and electromagnetic bar to extend downwardly relative to the rod and spool cylinder into the position shown in FIG. 9B, causing the gas in the sealed cavity 68a to expand. When the cylinder is rotated such that the electromagnetic bar is not on the bottom side of the cylinder and the force of gravity acting on the electromagnetic bar is above the spool cylinder, the gas in the sealed cavity 68a compresses back to its original volume, as the rod and piston retract back to the position shown in FIG. 9A Generally, a pick-up system extending across the entire width of the axial cylinder is preferred in order to give the pilot the greatest target area for a pick-up. In another embodiment, the gas cylinders may be actively moved between the extended and retracted positions by a compressed gas source and appropriate hydraulic valves as understood by those skilled in the art.

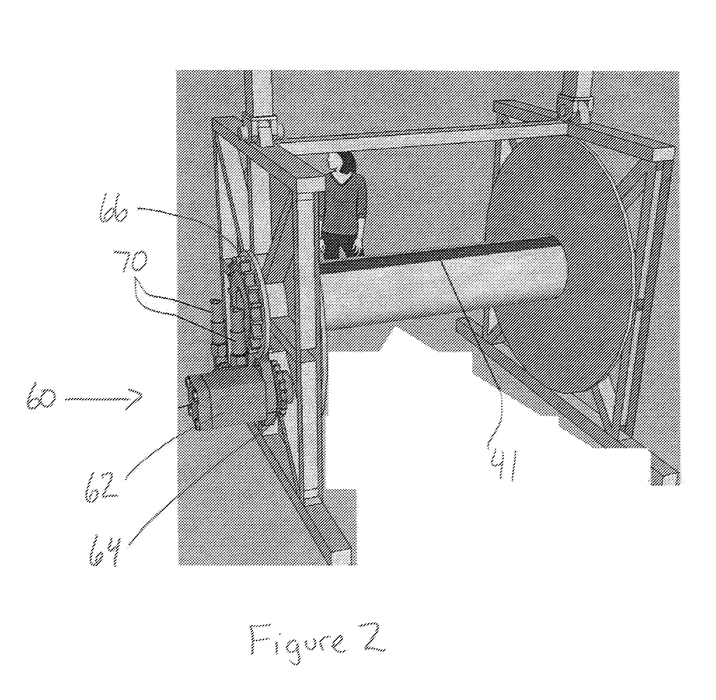

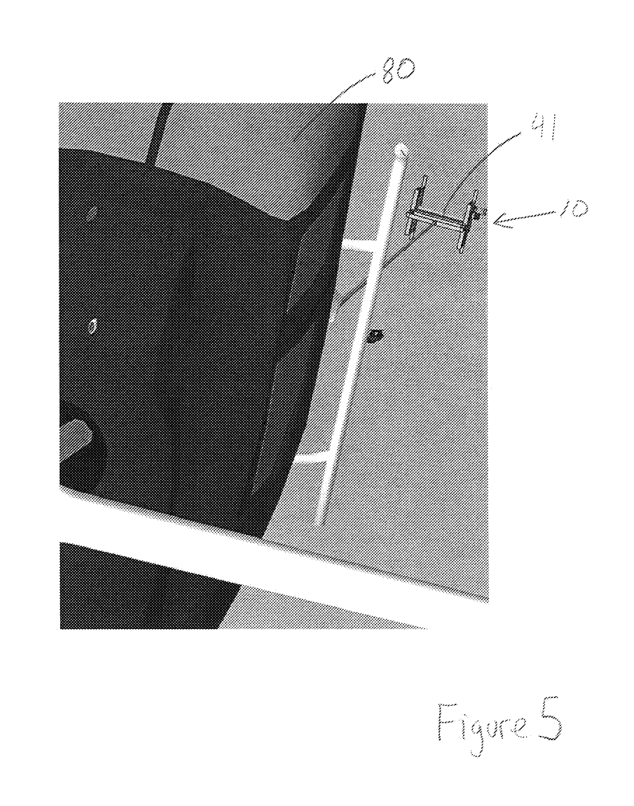

Referring to FIG. 2 and FIG. 5, the spool preferably includes a visual indicator 41 visible to the pilot when the cylinder is positioned such that the electromagnetic bar is on the underside of the cylinder. In the preferred embodiment, the visual indicator is a colored line extending along the length of the cylinder on the opposite side of the cylinder as the electromagnetic bar. When the colored line is on the upper side of the cylinder and visible to the pilot, the electromagnetic bar is on the underside of the cylinder and ready for being extended to pick up the hose.

While the pick-up system has been described using gas cylinders or a scissor mechanism to extend and retract an electromagnetic bar, other methods of extending and retracting the electromagnetic bar may be used.

In another embodiment, the pick-up system is a simple chain and a hook. In this example, when the aircraft is hovering, a person on the ground can manually attach the hook to an end of the fire hose. The hose can then by wound on the reel as described below. Other automatic, semi-automatic or manual attachment devices may be used as well.

### Drive System and Controls

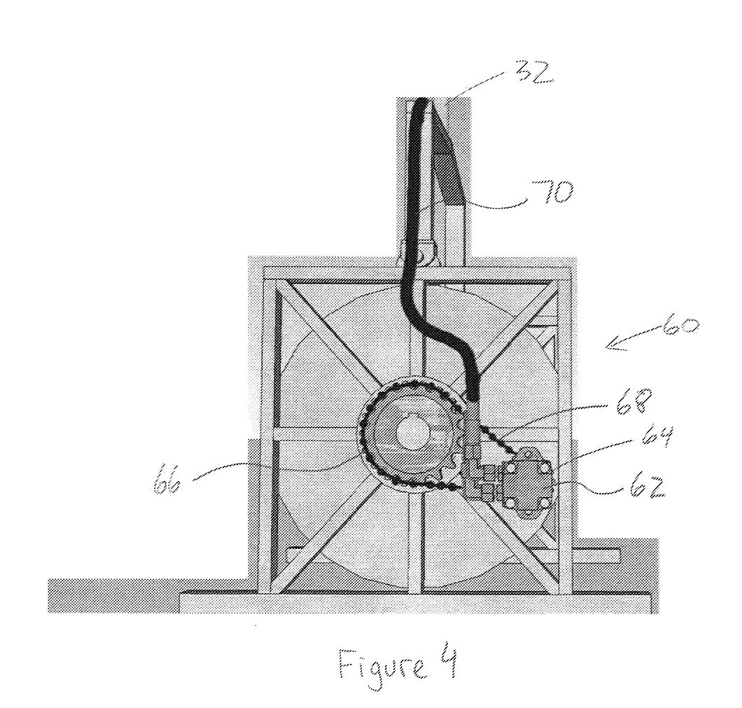

Referring to FIG. 2 and FIG. 4, in one embodiment the drive system 60 includes a hydraulic motor 62, a first gear 64, a second gear 66, a chain 68 and hydraulic lines 70. The hydraulic motor is secured to the frame 20 of the aerial reel and driven via the hydraulic lines. The hydraulic lines are connected to a hydraulic pump unit (not shown) which is connected to the aircraft controls for controlling the drive system. The first gear is connected to the hydraulic motor, the second gear is connected to the spool 40 or is part of the spool such that rotation of the gear causes rotation of the spool, and the chain connects the first and second gear to transfer energy from the motor to the spool. The hydraulic motor is reversible to allow for two-way rotational movement of the spool. In one embodiment, the drive system includes more than one gear ratio to allow for different rotational speeds of the spool. The drive system, including the actuation of the hydraulic motor, the direction of the hydraulic motor, and the gear ratio being used, is controlled through the aircraft controls by the pilot. The rotational speed of the spool and therefore the spooling and unspooling speed of the fire hose is coordinated with the speed the aircraft is travelling, as discussed in further detail later. In one embodiment, the spooling speed may be automatically adjusted based on the aircraft speed.

The drive system may also be an electric system wherein an electric generator may be carried on either the aerial power reel or helicopter. Similarly, a hydraulic power unit may be carried on the aerial reel. In both the hydraulic and electrical embodiments, the drive system may also be provided with wireless controls such that the operator is able to effect winding or unwinding from the cockpit without the need for running wiring specifically into the cockpit. Similarly, the controls for the pick-up/release system may be wirelessly controlled.

### Operation

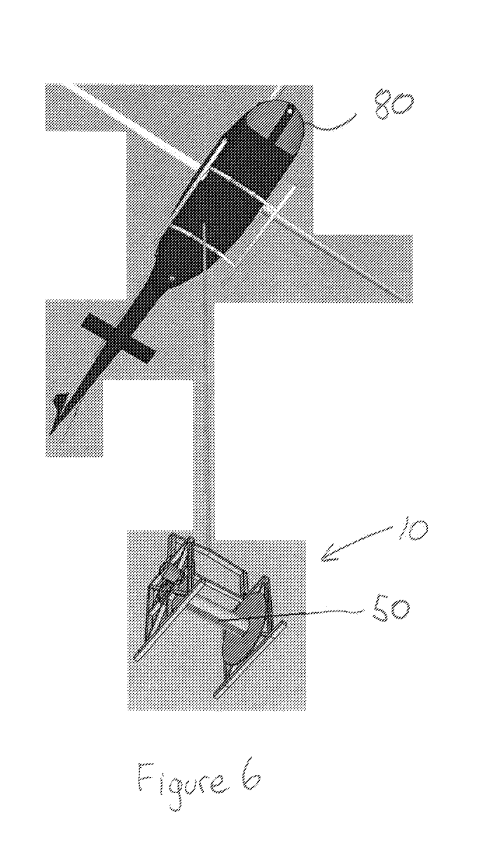

The aerial reel 10 is generally attached to a helicopter, while the aircraft is hovering above the ground. With the helicopter above the aerial reel, the connector 32 is attached to the appropriate mechanical/electrical/hydraulic connection systems on the bottom of the aircraft as per external load procedures known to those skilled in the art. The hinges 30a, 30b of the attachment system 30 pivot to facilitate the connection to the connector 32 and control lines. After connection, the aircraft will fly to the location to deploy or collect hose. After arriving at the desired location, the rotational direction and speed of the spool and the actuation of the pick-up system is controlled by the pilot of the aircraft 80 via the cockpit controls. FIG. 6 shows the aerial reel 50 suspended from the aircraft 80.

In the case of picking up fire hose onto an empty spool having an electromagnetic pick-up system, the pilot will fly towards and hover over one end of the fire hose. To prepare the aerial reel for picking up the hose, the pilot rotates the spool until the visual indicator is visible to indicate to the pilot that the pick-up system is on the underside of the spool. The pilot extends the electromagnet bar and actuates the electromagnetic bar to magnetize the bar. The pilot then finely adjusts the aircraft position such that connection between the hose coupling and electromagnetic bar is achieved. After the hose coupling is secured, the electromagnetic bar is retracted to its original seated position. The pilot then initiates rotation of the spool to start the winding process of hose around the spool. As the spool is being rotated, the pilot can also initiate forward flight along the length of the hose to prevent the hose from being dragged along the ground. The pilot will generally lift the aerial reel to a sufficient height such that any water in the hose will be drained out of the trailing end of the hose via gravity as the hose is spooled, thereby combining the step of draining and rolling the hose into one procedure.

After the fire hose is wound around the spool, the pilot flies to the area where the hose either needs to be laid out again or deposited for storage or other transportation.

If deploying the hose, the pilot hovers with the aerial reel above the ground and rotates the spool in the opposite direction used to wind the hose onto the spool, effectively unwinding the hose from the spool. As the hose is unwinding, the pilot flies the aircraft substantially parallel to the ground to lay out the hose along the ground in the desired path. The speed of the aircraft and the rotational speed of the spool are coordinated in order to keep a fairly constant tension in the hose such that it is laid out in a substantially straight line. Typically, the aircraft flies around 10-15 mph (16-24 kph).

As the hose is being laid out, the direction of the hose path can easily be manipulated by changing the aircraft flight direction. The hose can be laid across natural and/or artificial barriers encountered such as swamps, ponds, rock bluffs and the like, or the hose can be diverted around such barriers.

When many fire hoses need to be deployed in an area, it is efficient to drop a trailer or pallet loaded with hoses in the area, either by aircraft or ground transport. The helicopter slinging the aerial reel can simply pick-up a fire hose from the load of hoses, lay the hose out, and return to the load of hoses to repeat this procedure as many times as necessary, reducing flight time and eliminating the need for a ground crew to lay out the hoses.

Importantly, the system is also provided with an emergency release system to immediately release the aerial reel from the aircraft in the event of an emergency.

### Hot and Cold Spools

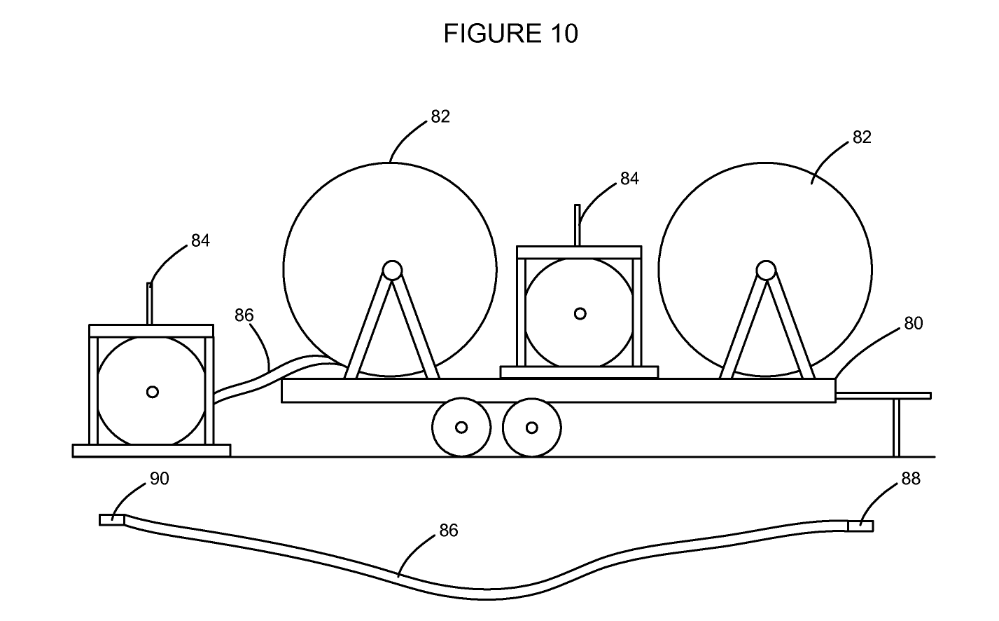

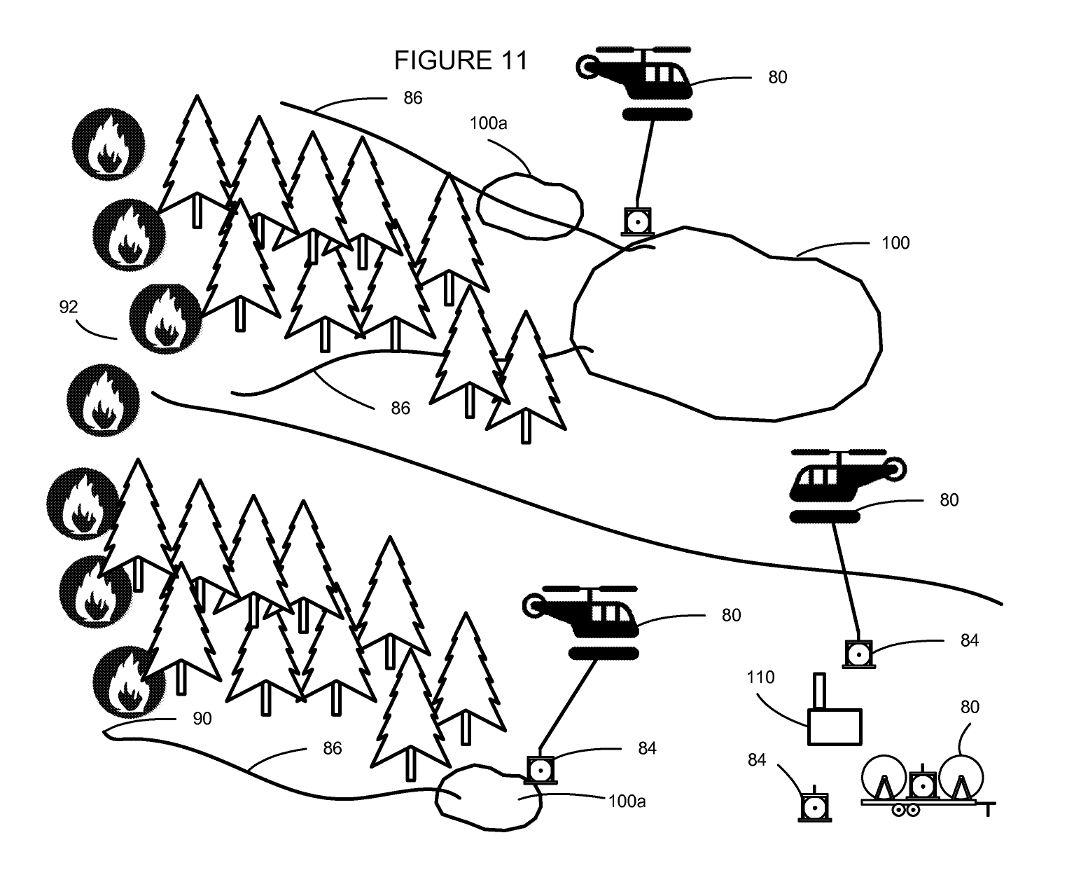

In another aspect, the invention provides a system for improving the efficiency of deployment and collection of hose within the field. As shown in FIGS. 10 and 11, a trailer 80 having one or more “cold” spools 82 may be configured to the trailer making available an inventory of hose for deployment and collection in the field. For example, a trailer may be driven to a fire site, with the trailer holding many thousands of feet of hose on each of two large spools 82. The hose is typically supplied in 100 foot lengths which are connected together and wound on to the spool. In addition, the trailer may also carry one or more (preferably 2-3) aerial power reels (APR) 84 (the “hot” spools). At the fire site, a ground crew will unload the APRs and commence transferring lengths of hose from the large spools to the smaller APRs (potentially up 2000 feet on one APR). When loading an APR, personnel with activate an APR to transfer the hose and once a desired number of lengths have been transferred, disconnect the APR from the cold spool. A power unit may be provided on the trailer to provide power to the APR. After an APR has been loaded, a helicopter will collect and deploy the hose on an APR. While the helicopter is deploying the first APR, a second and/or third APR may be prepared. The helicopter will return with an empty APR and pick-up a loaded APR. As such, the process can be repeated such that the helicopter does not need to wait for hose to be loaded onto the APRs but instead can efficiently collect and deploy hose from successive APRs. As shown in FIG. 11, multiple helicopters 80 can be working in an area collecting and delivering hose to multiple locations. As shown, the hose may be run from a water source 90 towards a fire line 92 and may be lain across small lakes 90a.

Similarly, hose can be collected from the field in the same manner.

### RFID Tag and GPS System

In one embodiment, each hose 86 is provided with a radio frequency identification (RFID) tag 90 within the connector sections 88 of and the APR is provided with a corresponding reader system. This RFID tag system allows the operator to effectively monitor the location of multiple lengths of hose that can facilitate inventory control and flight planning in the field. Importantly, the RFID system may be used in connection with a GPS system in order that the location of specific hoses in the field can be mapped and monitored at a central location on a computer 110. For example, as shown in FIG. 11, as an APR is being loaded with hose at central location, the RFID system will detect and record the ID number of a specific length of hose within a RFID database on computer 110. The ID number may be recorded as a loaded hose. Thereafter, when the APR is picked up by the helicopter, the ID number will be wirelessly transferred to the GPS system of the helicopter. Movement of the helicopter will mark the ID number as “in transit”. When the helicopter arrives at the deployment location and deploys the hose, at the moment the hose is disconnected from the APR, the ID number will be recorded as deployed hose within the GPS system. The GPS system will then record the deployed hose ID number at a specific GPS position. As multiple hoses are deployed, the GPS system will thereby record the location of each hose which can be plotted on a map. Individual helicopters will record the location of each hose within their individual on board GPS systems. This location data may be reported back to the central computer through a number of different networks depending on the availability of different networks. For example, if the fire location is within a cellular network, the location data may be reported to the central computer using a cellular network. If a cellular network is not available, the helicopters may utilize a satellite network to report data back to the central computer. Alternatively, the system may be deployed such that GPS data from each helicopter is reported to the central computer only when the helicopter is in close proximity to the central computer using a wireless local area network.

As a result, when the central computer has been updated showing the deployment of each hose, at the time that collection of the hoses is required, the operators can plan the pick-up procedure based on the location map, thereby improving the efficiency of pick-up. It should also be noted that a central computer need not be located in the field and that two-way updating of GPS data to a central computer and between helicopters can be achieved using appropriate wide area network communication.

When a specific hose is being picked up and is connected to the APR, the RFID system will read the ID number and if it exists in the RFID database, will change the status from deployed to collected. If for whatever reason, the ID number is not correctly identified in the database, the system will be updated to confirm the current status of the specific length of hose.

As the APR is moved, the GPS system may updated to indicated that the hose is in transit. The hose may be returned to the trailer or alternatively re-deployed in the field with its status being updated accordingly.

In addition, the trailer may have an RFID reader system to associate specific lengths of hose as being loaded onto a specific cold spool. As a cold spool may contain multiple hose lengths a manual RFID scanner may be utilized to record the location of the hose length with a specific cold spool.

The combined RFID and GPS system is particularly effective within complex fire-fighting operations where multiple trailers and multiple helicopters may be in operation at the same time as shown in FIG. 11.

### Other Uses

Although the aerial reel has been described with respect to the laying out of hose for fire fighting, the aerial reel can be used for laying out any flexible length of material such as a hose, wire, rope, lines or cable. In particular, the aerial reel can be used to lay out waterlines for delivering and pumping water for agricultural use, drilling operations (i.e. diamond mining) and disaster relief (i.e. flood relief). The aerial reel can also be used for stringing cable for communication purposes, such as hydro cable or seismic cable, or rope or cable for rescue purposes.

Although the present invention has been described and illustrated with respect to preferred embodiments and preferred uses thereof, it is not to be so limited since modifications and changes can be made therein which are within the full, intended scope of the invention as understood by those skilled in the art.

1. An aerial reel for operative connection to an aircraft for picking up and deploying lengths of flexible material to and from the aerial reel, the aerial reel comprising:
a rotatable spool having a frame for operative attachment to the aircraft;
an actuatable drive system operatively connected to the rotatable spool and frame for selective rotation of the rotatable spool with respect to the frame;
a pick-up system operatively attached to the rotatable spool, the pick-up system for attaching an end of a length of flexible material to the rotatable spool to facilitate winding of lengths of flexible material on the rotatable spool.

2. The aerial reel of claim 1 wherein the pick-up system includes a pick-up control system within the aircraft enabling operator actuation of the pick-up system from within the aircraft.

3. The aerial reel of claim 2 wherein the pick-up system includes an extension and retraction system for extending the pick-up system outwardly from the rotatable spool.

4. The aerial reel of claim 3 wherein the rotatable spool includes a central rotatable core and the extension and retraction system is operatively connected to the central rotatable core.

5. The aerial reel of claim 4 wherein the extension and retraction system is a passively or actively driven gas cylinder system.

6. The aerial reel of claim 5 wherein the extension and retraction system passively extends away from the central rotatable core when the extension and retraction system is positioned on the underside of the central rotatable core.

7. The aerial reel of claim 3 wherein the extension and retraction system is an actuatable scissor mechanism.

8. The aerial reel of claim 1 wherein the pick-up system includes an actuatable electromagnet.

9. The aerial reel of claim 8 wherein the electromagnet is a bar that extends along the length of the spool.

10. The aerial reel of claim 9 wherein the rotatable spool comprises first and second flanges on either ends of the cylinder, and at least one of the flanges has a track on an inner surface engaged with at least one of the ends of the electromagnetic bar for guiding the extension and retraction of the electromagnetic bar.

11. The aerial reel of claim 1 wherein the pick-up system comprises a hook.

12. The aerial reel of claim 1 wherein the rotatable spool further comprises a visual indicator for indicating the position of the pick-up system.

13. The aerial reel of claim 12 wherein the visual indicator is a colored line along the length of the rotatable spool on the opposite side of the rotatable spool relative to the pick-up system.

14. The aerial reel of claim 1 wherein the actuatable drive system includes a drive control system for connection within the aircraft enabling operator control of rotation of the rotatable spool from within aircraft.

15. The aerial reel of claim 1 wherein the actuatable drive system includes a hydraulic drive system having a hydraulic motor.

16. The aerial reel of claim 1 wherein the actuatable drive system includes an electric drive system having an electric motor.

17. The aerial reel of claim 1 wherein the actuatable drive system has a gear system having more than one gear ratio enabling the generation multiple spool rotation speeds.

18. The aerial reel of claim 17 wherein the gear ratio of the actuatable drive system has means for automatically adjusting the speed of rotation of the rotatable spool based on the speed of the aircraft.

19. The aerial reel of claim 1 wherein the bottom of the frame includes at least one skid for supporting the aerial reel in an upright orientation.

20. The aerial reel of claim 1 further comprising at least one rigid or semi-rigid connection line for attaching the frame to the aircraft and wherein the connection line when attached to the aerial reel prevents the aerial reel from spinning about a vertical axis relative to the aircraft while aloft.

21. The aerial reel as in claim 1 further comprising a radio frequency identification (RFID) reader operatively connected to the rotatable spool for detecting an RFID tag operatively connected to a length of the flexible material.

22. An aerial reel for suspension from an aircraft comprising:
a frame;
a rotatable spool in operative connection with the frame, the rotatable spool including a reversible drive system for rotating the spool in clockwise and counterclockwise directions, the drive system including a drive control system for connection to the aircraft enabling operator control of the rotatable spool from within the aircraft; and
a pick-up system in operative connection with the rotatable spool, the pick-up system including:
an actuatable electromagnetic bar extending along the length of the rotatable spool and rotatable with the rotatable spool for attaching to a flexible length of material to be carried on the rotatable spool;
an extension and retraction system for extending the electromagnetic bar outwardly from the rotatable spool and retracting the electromagnetic bar inwardly towards the rotatable spool; and
a pick-up control system connected to the aircraft enabling operator control of the aerial reel from within the aircraft.

23. A system for managing the deployment and collection of fire-fighting hose comprising:
a plurality of hose lengths each having an radio frequency identification (RFID) tag;
at least one aerial reel for operative connection to an aircraft, each at least one aerial reel having an RFID reader operatively connected to the aerial reel, the RFID reader detecting the attachment or disconnection of a specific hose length to the aerial reel;
a hose database operatively connected to each RFID reader, the hose database having means for marking a specific hose length as attached to or disconnected from an aerial reel.

24. A system as in claim 23 further comprising a GPS mapping system operatively connected to the hose database, wherein the GPS system maps the location of an individual hose length when a hose length is disconnected from an aerial reel.

25. A system as in claim 24 wherein the system includes separate GPS mapping systems in individual aircraft, each GPS mapping system receiving and storing RFID and GPS data of individual hose lengths carried and deployed by the individual aircraft.

26. A system as in claim 25 wherein the separate GPS mapping systems include means for transferring RFID and GPS data stored within each GPS mapping system to a central computer via a wide area or local area network.
